(19) United States
(12) Patent Application Publication
(10) Pub. No.: US 2026/0292692 A1
(43) Pub. Date: Sep. 24, 2026

(54) WAKEUP SIGNAL CONTROL OF POWERING DIE-TO-DIE INTERCONNECTS

(71) Applicant: QUALCOMM Incorporated, San Diego, CA (US)

(72) Inventors: Sang TRAN, Encinitas, CA (US); Rongtian ZHANG, San Diego, CA (US)

(21) Appl. No.: 19/088,827

(22) Filed: Mar. 24, 2025

(51) Int. Cl. H04W 52/02; G06F 12/02; H04W 76/28

(52) U.S. Cl. CPC H04W 52/0235; G06F 12/0238; H04W 76/28

(57) ABSTRACT

A communication node such as a user equipment is provided that controls an on and off state of interconnects including die-to-die and DDR DRAM interfaces in response to a wakeup signal for discontinuous reception cycles. The resulting deterministic event-driven control of the interconnect power state advantageously lowers power consumption.

### TECHNICAL FIELD

The present application relates generally to on-off state control of die-to-die interconnects, and more particularly to a wakeup signal control of powering die-to-die interconnects.

### BACKGROUND

A system-on-a-chip (SOC) in a mobile device will typically be interfaced with additional integrated circuits in the device through die-to-die (D2D) interconnects. As the transistor sizes have shrunk into the nanometer range, the power consumption from data movement over the D2D interconnects has become a primary consumer of energy. The power consumption from moving data between integrated circuits is thus becoming greater than the subsequent processing of the data such as in a floating point operation. The resulting power consumption limits battery performance in the mobile devices.

### SUMMARY

In accordance with an aspect of the disclosure, a communication node is provided that includes: a radio front end configured to receive a wakeup signal, wherein the radio front end is further configured to be powered on during an on-duration of a current discontinuous reception cycle in response to a first value of the wakeup signal and to be powered down prior to and during the on-duration of the current discontinuous reception cycle in response to a second value of the wakeup signal; a first die including a first die-to-die interface; and a second die including a second die-to-die interface and an at least one processor, wherein the second die-to-die interface is coupled to the first die-to-die interface, and wherein the at least one processor is configured to control the first die-to-die interface and the second die-to-die interface to be powered off during a remainder of the current discontinuous reception cycle including the on-duration in response to the second value of the wakeup signal.

In accordance with another aspect of the disclosure, a method for a user equipment is provided that includes: receiving a first wakeup signal, wherein the first wakeup signal is a command to power on a radio front end of the user equipment during an on-duration of a first discontinuous reception cycle; maintaining a first die-to-die interconnect of a first processor die of the user equipment and a second die-to-die interconnect of a second processor die of the user equipment to be powered on during the on-duration of the first discontinuous reception cycle in response to the receiving of the first wakeup signal; receiving a second wakeup signal, wherein the second wakeup signal is a command to maintain the radio front end of the user equipment to be powered off during an on-duration of a second discontinuous reception cycle; and powering off the first die-to-die interconnect and the second die-to-die interconnect during at least a portion of the on-duration of the second discontinuous reception cycle in response to the receiving of the second wakeup signal.

Finally, in accordance with yet another aspect of the disclosure, a user equipment is provided that includes: a first die including a first die-to-die interface and an at least one processor, wherein the at least one processor is configured to command the first die-to-die interface to power off prior to an on-duration of a current discontinuous reception cycle in response to a first value of a wakeup signal.

These and other advantageous features may be better appreciated through the following detailed description.

### BRIEF DESCRIPTION OF THE DRAWINGS

FIG. 1 illustrates a communication network including user equipments each being configured to control the powering of interconnects in response to a wakeup signal in accordance with an aspect of the disclosure.

FIG. 2 illustrates some OFDM resources and slot structures for the communication network of FIG. 1.

FIG. 3A illustrates a user equipment from the communication network of FIG. 1 in more detail in which the application processor and the baseband processor occupy separate dies in accordance with an aspect of the disclosure.

FIG. 3B illustrates a user equipment from the communication network of FIG. 1 in more detail in which the application processor and the baseband processor are integrated in a common die in accordance with an aspect of the disclosure.

FIG. 4 illustrates a computer system implemented by an at least one processor in a die of the user equipment of FIG. 3A or FIG. 3B in accordance with an aspect of the disclosure.

FIG. 5 illustrates a timeline for a pair of discontinuous reception cycles for the user equipment of FIG. 3A or FIG. 3B in accordance with an aspect of the disclosure.

FIG. 6 is a flowchart for a method of controlling the interface on-off state in response to a wakeup signal in accordance with an aspect of the disclosure.

Implementations of the present disclosure and their advantages are best understood by referring to the detailed description that follows. It should be appreciated that like reference numerals are used to identify like elements illustrated in one or more of the figures.

### DETAILED DESCRIPTION

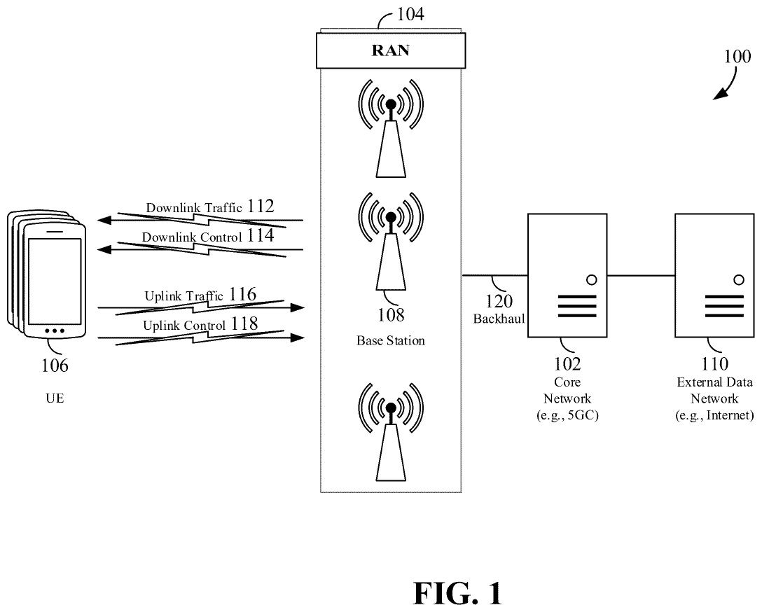

The power consumption by mobile devices is a primary factor in battery performance. If a user must recharge the battery too frequently, user satisfaction may suffer. A primary factor in this power consumption is the data movement over die-to-die (D2D) interconnects in a device. A communication node such as a mobile device for a New Radio (NR) communication network is disclosed herein that advantageously reduces the D2D interconnect power consumption to thus extend battery performance (assuming the device is battery powered) and increase user satisfaction. To reduce the D2D interconnect power consumption, the improved communication nodes disclosed herein utilize a wakeup signal such as the wakeup signal (WUS) introduced by Release 16 of the 3^{rd} Generation Partnership Project (3GPP). To provide a better appreciation of the D2D interconnect power savings disclosed herein, some basic concepts in NR networks will first be discussed with reference to an example wireless communication system 100 of FIG. 1 configured for the D2D interconnect power savings disclosed herein. The wireless communication system 100 includes three interacting domains: a core network 102, a radio access network (RAN) 104, and a plurality of NR user equipment (UE) 106. By virtue of the wireless communication system 100, each NR UE 106 may be enabled to carry out data communication with an external data network 110, such as (but not limited to) the Internet.

As illustrated, the RAN 104 includes a plurality of base stations 108. Each base station 108 is responsible for radio transmission and reception in one or more cells. In different technologies, standards, or contexts, a base station 108 may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), or some other suitable terminology.

The radio access network 104 is further illustrated supporting wireless communication for multiple communication nodes (e.g., UEs) 106 that may each be configured to practice the D2D interconnect power savings disclosed herein. A UE 106 may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a network device, or some other suitable terminology. Each UE 106 may be an apparatus that provides a user with access to network services.

Transmissions over the air interface from a base station 108 to one or more UEs 106 may be referred to as downlink (DL) transmissions. Transmissions from a UE 106 to a base station 108 may be referred to as uplink (UL) transmissions. As illustrated in FIG. 1, a base station 108 may broadcast downlink traffic 112 to one or more UEs 106. Each base station 108 is a node or device responsible for scheduling the downlink traffic 112 and, in some examples, uplink traffic 116 from the one or more UEs 106. On the other hand, each UE 106 is a node or device that receives downlink control information 114, including but not limited to scheduling information, synchronization or timing information, or other control information from a base station 108.

In general, base stations 108 may include a backhaul interface for communication with a backhaul portion 120 of the wireless communication system. The backhaul 120 may provide a link between a gNB (e.g., a base station) 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100 and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

In a network configured for UL-based mobility, UL reference signals from each UE 106 may be utilized by the network 104 to select a serving cell for each UE 106. In some examples, the base stations 108 may broadcast unified synchronization signals (e.g., unified Primary Synchronization Signals (PSSs), unified Secondary Synchronization Signals (SSSs) and unified Physical Broadcast Channels (PBCH)). The UEs 106 may receive the unified synchronization signals, derive the carrier frequency and slot timing from the synchronization signals, and in response to deriving the timing, transmit an uplink pilot or reference signal. The uplink pilot signal transmitted by a UE 106 may be concurrently received by two or more cells each having its own base station 108 within the radio access network 104. Each cell may measure a strength of the pilot signal, and the radio access network 104 may then determine a serving cell for the UE 106. As each UE 106 travels through a cell, the radio access network 104 may continue to monitor the uplink pilot signal transmitted by the UE 106. When the signal strength or quality of the pilot signal measured by a neighboring cell exceeds that of the signal strength or quality measured by the serving cell, the radio access network 104 may handover the UE 106 from the serving cell to a neighboring cell, with or without informing the UE 106.

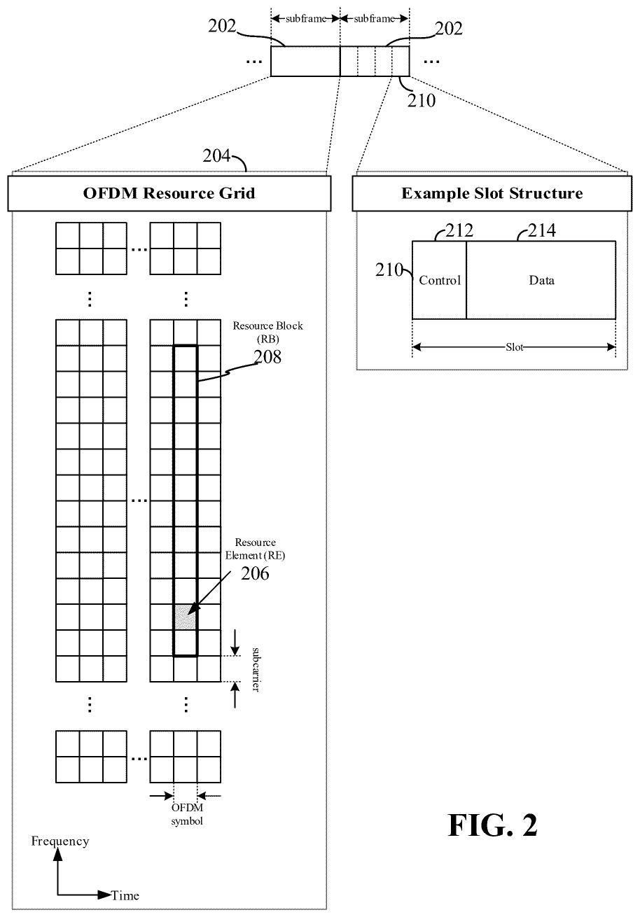

Various aspects of the present disclosure will be described with reference to an OFDM waveform, schematically illustrated in FIG. 2. Within the present disclosure, a frame refers to a duration of 10 ms for wireless transmissions, with each frame consisting of 10 subframes of 1 ms each. On a given carrier, there may be one set of frames in the UL, and another set of frames in the DL. An expanded view of an exemplary DL subframe 202 is also illustrated in FIG. 2, showing an OFDM resource grid 204. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers or tones.

The resource grid 204 may be used to schematically represent time-frequency resources for a given antenna port. That is, in a MIMO implementation with multiple antenna ports available, a corresponding multiple number of resource grids 204 may be available for communication. The resource grid 204 is divided into multiple resource elements (REs) 206. An RE 206, which is 1 subcarrier×1 symbol, is the smallest discrete part of the time-frequency grid, and contains a single complex value representing data from a physical channel or signal. A block of twelve consecutive subcarriers defined a resource block (RB) 208, which has an undefined time duration in the NR standard. In FIG. 2, resource block 208 extends over a symbol duration. Within the present disclosure, it is assumed that a single RB such as the RB 208 entirely corresponds to a single direction of communication (either transmission or reception for a given device). A set of contiguous RBs 208 form a bandwidth part (BWP).

Each 1 ms subframe 202 may consist of one or multiple adjacent slots. In the example shown in FIG. 2, one subframe 202 includes four slots 210, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots having a shorter duration (e.g., one or two OFDM symbols). These mini-slots may in some cases be transmitted occupying resources scheduled for ongoing slot transmissions for the same or for different UEs.

An expanded view of a slot 210 illustrates a control region 212 and a data region 214. In general, the control region 212 may carry control channels (e.g., the physical downlink control channel (PDCCH)), and the data region 214 may carry data channels (e.g., physical downlink shared channel (PDSCH) or physical uplink shared channel (PUSCH)). A slot 210 may contain all DL, all UL, or at least one DL portion and at least one UL portion. The simple structure illustrated in FIG. 2 is merely exemplary in nature, and different slot structures may be utilized, and may include one or more of each of the control region(s) and data region(s).

Although not illustrated in FIG. 2, the various REs 206 within an RB 208 may be scheduled to carry one or more physical channels, including control channels, shared channels, data channels, etc. Other REs 206 within the RB 208 may also carry pilots or reference signals, including but not limited to a demodulation reference signal (DMRS), or cell specific reference signal (CRS). These pilots or reference signals may provide for a receiving device to perform channel estimation of the corresponding channel, which may enable coherent demodulation/detection of the control and/or data channels within the RB 208.

Each UE in an NR network consumes power as it monitors its PDCCH to determine whether the corresponding gNB has scheduled a downlink transmission to the UE. But packet-data traffic is typically highly bursty such that data bursts are followed by even longer periods of no activity. It would consume substantial power for each UE to monitor its PDCCH during the inactive periods. To reduce this power consumption, NR uses a discontinuous reception (DRX) mode of operation. Within a DRX cycle, each UE monitors its PDCCH only during an active portion (on-duration) of the DRX cycle such that its receiver may be powered down during an inactive portion (off duration) of the DRX cycle. Depending upon the mode of operation, a UE may be scheduled over long DRX cycles or short DRX cycles. As implied by the names, the off durations of a long DRX cycle are longer than the off durations of a short DRX cycle. But given the bursty nature of data traffic, it may be the case that a UE awakens its receiver during the on duration of a long DRX cycle for naught as there are no downlink communications being scheduled the UE. Each on duration of both a long and short DRX cycle is timed using a DRX duration timer.

With regard to monitoring its PDDCH, a UE receives a payload over the PDCCH that is known as Downlink Control Information (DCI). DCI uses various formats including a format 2_6. To reduce the power consumption of monitoring the PDCCH in the on durations of long DRX cycles, Release 16 introduced a wake signal (also denoted as ps_WakeUp-r16) that uses a wakeup signal (WUS) bit within a DCI format 2_6 transmission. The WUS bit may also be denoted as a wake indication bit or signal. If a gNB asserts the WUS bit (the WUS bit equaling a binary one) for a UE, the UE is alerted to proceed with the subsequent on-duration of a long DRX cycle as timed by the DRX duration timer. But if the gNB de-asserts the WUS bit (the WUS bit equaling a binary zero), the UE is alerted to not wake up in the subsequent on-duration of the long DRX cycle such that the DRX duration timer is also off.

The following discussion will be directed to the use of the wakeup signal as defined by Release 16 (ps_WakeUp-r16). However, it will be appreciated that other types of wakeup signals that signal a UE to put its radio front end (RFFE) into a sleep mode may also be used. In that regard, the ps_WakeUp-r16 bit does not have an effect on the UE during short DRX cycles. But the power saving architectures disclosed herein are readily adapted to wakeup signals that are effective during any DRX cycle regardless of whether it is short or long. An example communication node will now be discussed in more detail.

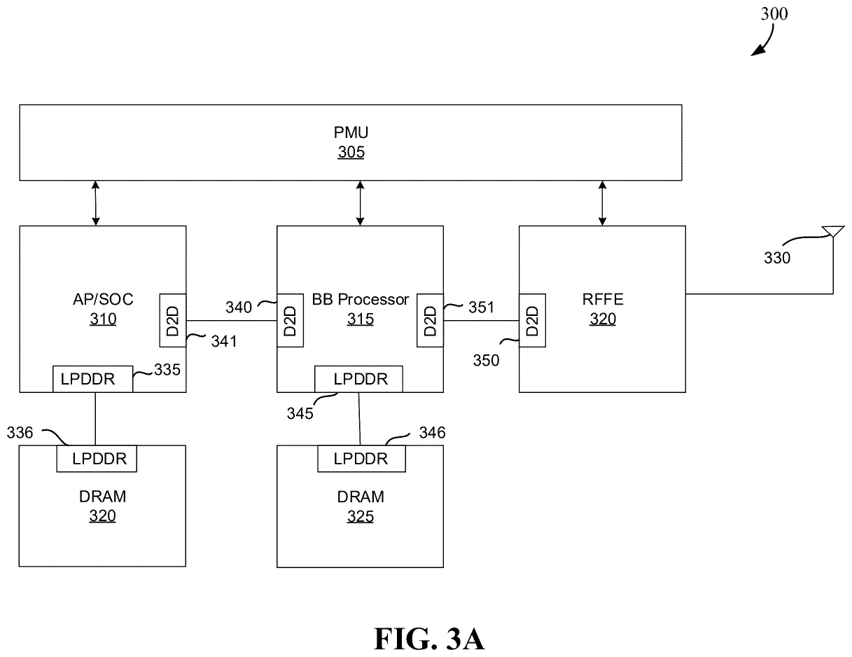

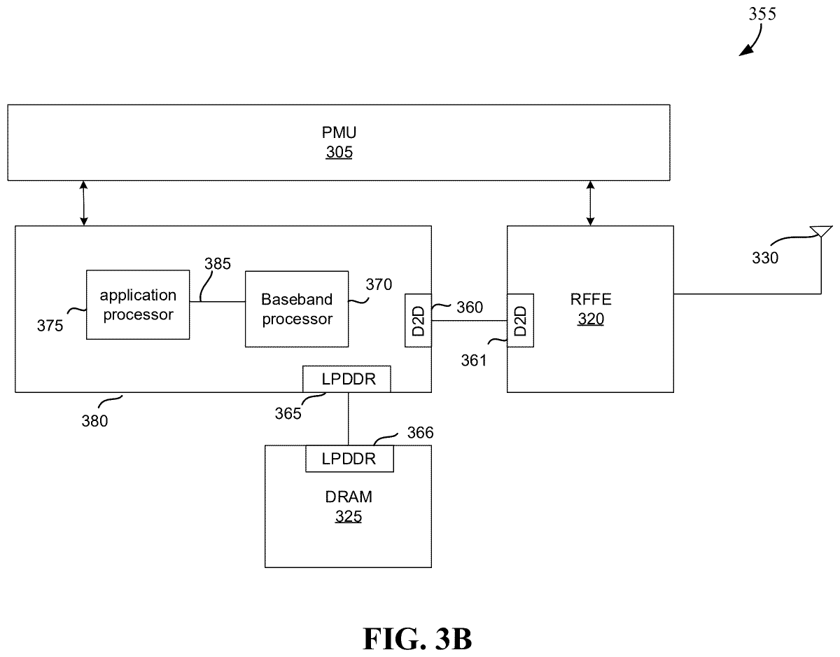

The UEs 106 in system 100 are configured to exploit a wakeup signal such as the ps_WakeUp-r16 bit by configuring their die-to-die interconnect power mode accordingly. An example communication node such as a UE 300 is shown in more detail in FIG. 3A. A radio front end (RFFE) 320 die receives a DCI transmission including the DCI format 2_6 through one or more antennas 330. The RFFE 320 converts the DCI transmission into a baseband digital signal that is transmitted through a D2D interface 350 to a corresponding D2D interface 351 in a baseband processor die 315. The baseband processor 315 recovers the ps_WakeUp-r16 bit from the digital baseband signal. In response to a binary zero value of the ps_WakeUp-r16 bit, the interfaces 350 and 351 are powered down because the RFFE 320 will transition into a sleep mode in which it may be powered down. The baseband processor 315 may then alert an application processor die 310 (which may also be denoted as an SOC 310) of the binary zero value of the ps_WakeUp-r16 bit through D2D interfaces 340 and 341. The D2D interfaces 340 and 341 may be any suitable D2D interface such Peripheral Component Interconnect Express (PCIE) interfaces, Secure Digital Input/Output (SDIO) interfaces, or intelligent SDIO (iSDIO) interfaces.

During regular or active mode operation the application processor 310 may access a memory die such as a double data rate (DDR) dynamic random-access memory (DRAM) die 320 through suitable interfaces such as Joint Electron Device Engineering Council (JEDEC) low-power DDR (LPDDR) interfaces 335 and 336. Alternatively, interfaces 335 and 336 may be implemented as DDR synchronous DRAM (DDR SDRAM) interfaces such as DDR4 or DDR5 SDRAM interfaces. Similarly, the baseband processor 315 may access a DDR DRAM die 325 through suitable DDR DRAM interfaces such as LPDDR interfaces 345 and 346 during its active mode of operation. The powering of the D2D interfaces 340 and 341 and the LPDDR interfaces 335, 336, 345 and 346 is thus a major contributor to the power consumption budget for the UE 300. To address this power consumption, the application processor 310 is configured to respond to the binary zero value of the ps_WakeUp-r16 signal by determining when to power down the D2D interfaces 340 and 341 and the LPDDR interfaces 335, 336, 345, and 346. In contrast, it was typical for the control of the D2D interfaces between processors in a communication node such as a UE to be statistically based on the likelihood of data transmission. But such statistical control is not precise as compared to the use of a wakeup signal as disclosed herein. The use of the wakeup signal leads to a deterministic event-driven control of the powering of baseband and application processor interfaces and reduces power consumption as compared to a statistical approach.

The application processor 310 (and/or the baseband processor 315) is configured to respond to a wakeup signal that signals that the UE 300 is not to activate an on-duration timer during a current DRX cycle. In the following discussion, it will be assumed that the wakeup signal is a binary zero value of the ps_WakeUp_r16 signal, but it will be appreciated that other suitable wakeup signals may be used in alternative implementations. In response to the binary zero value of the ps_WakeUp_r16 signal, the application processor 310 may transfer any remaining buffered data it has to send to the baseband processor 315 over the D2D interfaces 340 and 341. Similarly, the baseband processor may transfer any buffered data it has to send to the application processor 310 through the D2D interfaces 340 and 341. With the buffered data transferred, the application processor 310 and/or the baseband processor 315 may then configure a power management unit 305 (e.g., a power management integrated circuit (PMIC)) to power down the D2D interfaces 350, 351, 340 and 341 and also power down the LPDDR interfaces 335, 336, 345, and 346. Alternatively, the power management unit 305 may transition the interfaces 350, 351, 340, 341, 335, 336, 345, and 346 to a low-power mode in which their power supply voltage(s) are reduced. The delay time between the application processor 310 receiving the binary zero value of the ps_WakeUp_r16 signal and the powering down of the interfaces 350, 351, 340, 341, 335, 336, 345, and 346 may be programmable based upon the amount of the buffered data to be sent from the application processor 310 to the baseband processor 315 and/or upon the amount of buffered data to be sent from the baseband processor 315 to the application processor 310. Alternatively, the delay time may end upon a completion of a transmission of the buffered data. Based upon the ps_WakeUp-r16 signal, the application processor 310 and/or the baseband processor 315 may thus intelligently continue to buffer data or transfer immediately without waiting until a subsequent DRX cycle.

The UE 300 may be modified as shown for a UE 355 of FIG. 3B. The RFFE die 320 and the PMU 305 are arranged as discussed for the UE 300. However, an application processor 375 and a baseband processor 370 are integrated into a single die 380 in the UE 355. Die 380 communicates with the RFFE 320 through a pair of D2D interfaces 360 and 361. Die 380 includes an LPDDR interface 365 for interfacing with one or more DDR DRAMs 325 through corresponding LPDDR interfaces 366. During regular or active mode operation, the application processor 375 interfaces with the baseband processor 370 through an intra-chip interface 385 such as a network-on-a-chip, a networking fabric, a cross-bar, or a bus. To address the power consumption by the intra-chip interface 385 and the LPDDR interfaces 365 and 366, the application processor 375 and/or the baseband processor 370 is configured to respond to a suitable wakeup signal such as a binary zero value of the ps_WakeUp-r16 signal by determining when to power down the intra-chip interface 385, the D2D interfaces 350 and 351, and the LPDDR interfaces 365 and 366 analogously as discussed for the user equipment 300.

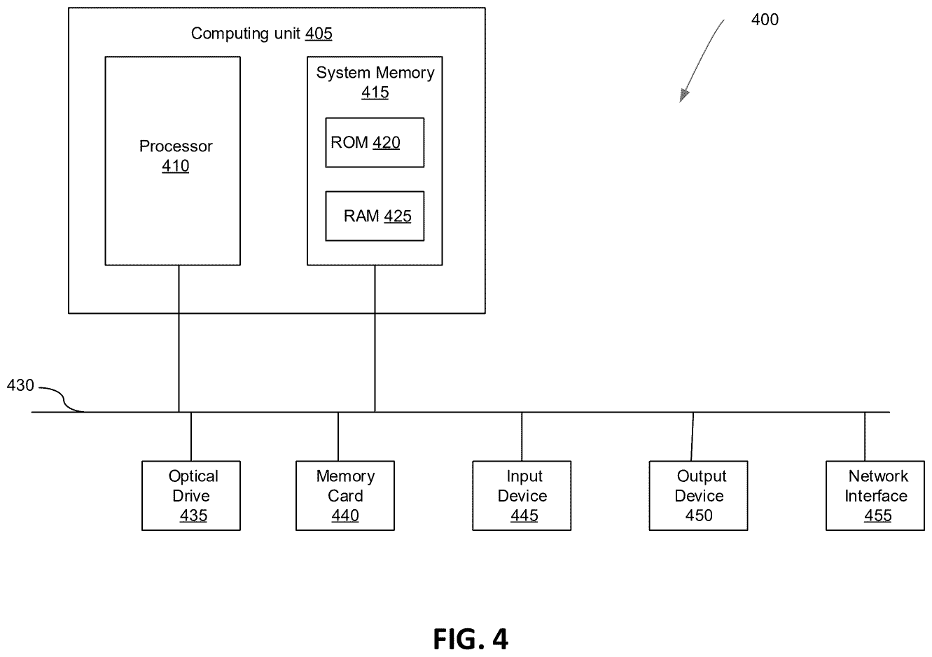

The application processor 310 or 370 may be part of a mobile device computing system 400 as shown in FIG. 4. As seen in this figure, the computing system 400 includes a computing unit 405 with an at least one processor 410 (e. g, the application processor 310 or 375 or the baseband processor 315 or 370) that executes instructions from and stores data in a system memory 415. The at least one processor 410 may be any type of programmable electronic device for executing software instructions but will typically be one or more microprocessors. The system memory 415 may include both a read-only memory (ROM) 420 and a random-access memory (RAM) 425 (e.g., the DRAM 320). As will be appreciated by those of ordinary skill in the art, both the read-only memory (ROM) 420 and the random-access memory (RAM) 425 may store software instructions for execution by the at least one processor 410.

The at least one processor 410 and the system memory 415 are connected, either directly or indirectly, through a bus 430 or alternate communication structure, to one or more peripheral devices. For example, the at least one processor 410 or the system memory 415 may be directly or indirectly connected to one or more additional memory storage devices such as an optical disk drive 435, or a flash memory card 440. The at least one processor 410 and the system memory 415 also may be directly or indirectly connected to one or more input devices 445 and one or more output devices 450. The input devices 445 may include, for example, a keyboard, a pointing device (such as a mouse, touchpad, stylus, trackball, or joystick), a scanner, a camera, and a microphone. The output devices 445 may include, for example, a monitor display, a printer and speakers.

With some implementations, the computing system 400 may be directly or indirectly connected to one or more network interfaces 455 for communicating with other devices making up a network. The network interface 455 translates data and control signals from the computer system 400 into network messages according to one or more communication protocols, such as the transmission control protocol (TCP) and the Internet protocol (IP). Also, the interface 455 may employ any suitable connection agent (or combination of agents) for connecting to a network, including, for example, a wireless transceiver, a modem, or an Ethernet connection. Such network interfaces and protocols are well known in the art, and thus will not be discussed here in more detail. It should be appreciated that the computing system 400 is illustrated as an example only, and it not intended to be limiting. Various implementations may be formed using one or more computing systems that include the components of the system 400 illustrated in FIG. 4 or which include only a subset of the components illustrated in FIG. 4, or which include an alternate combination of components, including components that are not shown in FIG. 4.

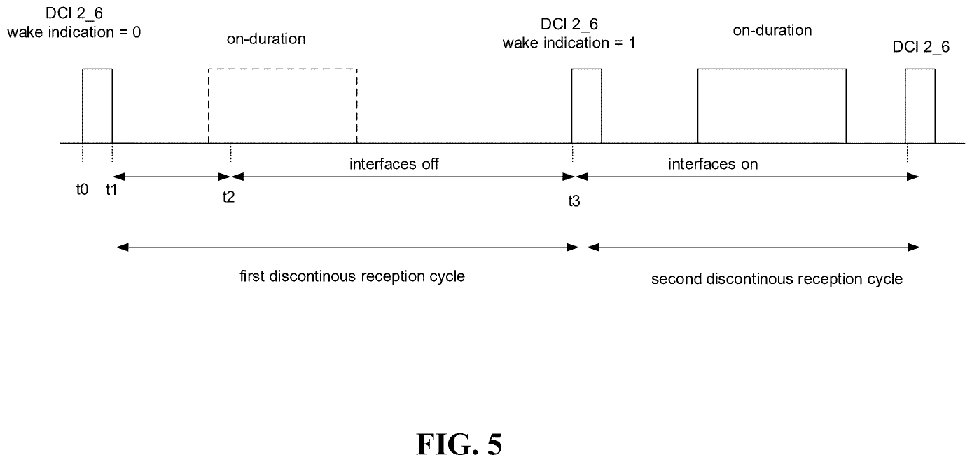

The deterministic event-driven control of the die-to-die interfaces between processor dies (e.g., an application processor and a baseband processor) of a UE and of DDR DRAM interfaces between the dies and corresponding DDR DRAMs based upon the wakeup signal is also illustrated in the timeline of FIG. 5. Alternatively, the timeline of FIG. 5 illustrates the control of the intra-chip interface and the DDR DRAM interfaces should the application processor and the baseband processor be integrated into a single integrated circuit as discussed for FIG. 3B. A first discontinuous reception cycle begins at a time t0 with a DCI 2_6 message being received having a wake indication equaling a binary zero. An RFFE thus remains powered down during an on-duration of the first discontinuous reception cycle. In response to the wake indication equaling zero a first processor die (e.g., an application processor) transmits buffered data it had to the second processor die from a time t1 to a time t2. In this case, the buffered data transmission was such that time t2 extended into the on-duration but this buffered data transmission may end prior to the on-duration depending upon the buffered data size (if any). The die-to-die interfaces (or the intra-chip interface) and the DDR DRAM interfaces for the processor die(s) are powered down from time t2 to a time t3 at a termination of the first discontinuous reception cycle in response to the wake indication being a binary zero. More generally, the interfaces are powered down for at least a portion of the on-duration of the first discontinuous reception cycle in response to the wake indication having a first value. At time t3, a DCI 2_6 message is received for a second discontinuous reception cycle in which the wakeup signal has a second value (e.g., the wake indication being a binary one). The interfaces for the two processor dies are thus maintained on during the second discontinuous reception cycle.

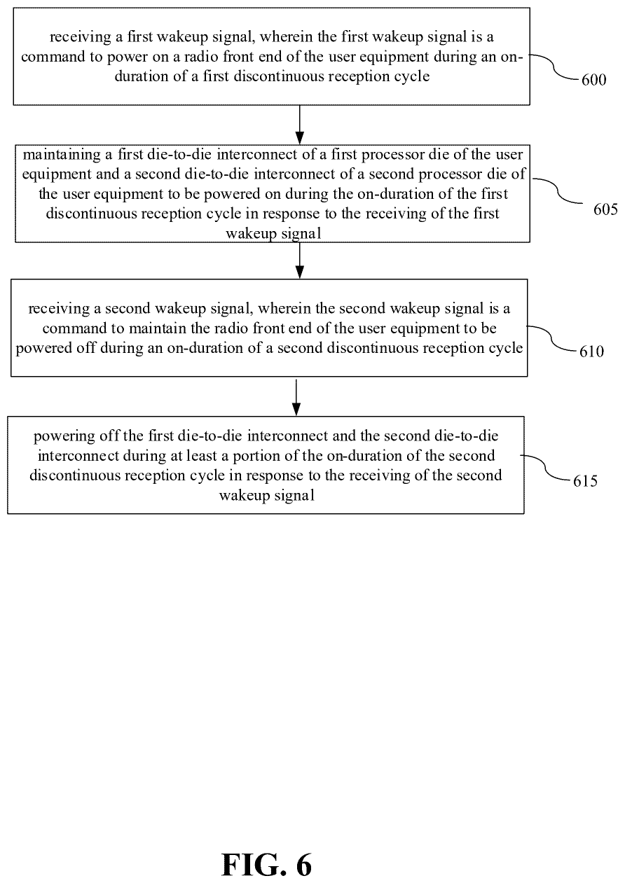

A method of controlling the on-off state of interfaces in a user equipment will now be summarized with respect to the flowchart of FIG. 6. The method includes an act 600 of receiving a first wakeup signal, wherein the first wakeup signal is a command to power on a radio front end of the user equipment during an on-duration of a first discontinuous reception cycle. The receipt of a wakeup signal such as the wakeup signal in the second discontinuous reception cycle of FIG. 5 is an example of act 600. The method further includes an act 605 of maintaining a first die-to-die interconnect of a first processor die of the user equipment and a second die-to-die interconnect of a second processor die of the user equipment to be powered on during the on-duration of the first discontinuous reception cycle in response to the receiving of the first wakeup signal. The maintaining of the die-to-die interfaces on during the on-duration of the second discontinuous reception cycle of FIG. 5 is an example of act 605. The method also includes an act 610 of receiving a second wakeup signal, wherein the second wakeup signal is a command to maintain the radio front end of the user equipment to be powered off during an on-duration of a second discontinuous reception cycle. The receiving of the wakeup signal during the first discontinuous reception cycle of FIG. 5 is an example of act 610. Finally, the method includes an act 615 of powering off the first die-to-die interconnect and the second die-to-die interconnect during at least a portion of the on-duration of the second discontinuous reception cycle in response to the receiving of the second wakeup signal. The powering off of the die-to-die interfaces at time t2 of the first discontinuous reception cycle of FIG. 5 is an example of act 615.

Some example implementations will now be summarized through the following numbered clauses:

Clause 1. A communication node, comprising:
a radio front end configured to receive a wakeup signal, wherein the radio front end is further configured to be powered on during an on-duration of a current discontinuous reception cycle in response to a first value of the wakeup signal and to be powered down prior to and during the on-duration of the current discontinuous reception cycle in response to a second value of the wakeup signal;
a first die including a first die-to-die interface; and
a second die including a second die-to-die interface and an at least one processor, wherein the second die-to-die interface is coupled to the first die-to-die interface, and wherein the at least one processor is configured to control the first die-to-die interface and the second die-to-die interface to be powered off during a remainder of the current discontinuous reception cycle including the on-duration in response to the second value of the wakeup signal.

Clause 2. The communication node of clause, wherein the at least one processor is an application processor and wherein the second die includes a baseband processor.

Clause 3. The communication node of clause 1, wherein the at least one processor is a baseband processor and wherein the second die includes an application processor.

Clause 4. The communication node of any of clauses 1-3, wherein the first die-to-die interface and the second die-to-die interface each comprises a peripheral component interconnect express interface.

Clause 5. The communication node of any of clauses 1-3, wherein the first die-to-die interface and the second die-to-die interface each comprises a configurable general-purpose input/output (GPIO) interface.

Clause 6. The communication node of any of clauses 1-5, further comprising:
a first double data rate dynamic random-access memory (DDR DRAM) including a first DDR DRAM interface, wherein the second die includes a second DDR DRAM interface coupled to the first DDR DRAM interface, and wherein the at least one processor is further configured to control the first DDR DRAM interface and the second DDR DRAM interface to be powered down during the remainder of the current discontinuous reception cycle in response to the second value of the wakeup signal.

Clause 7. The communication node of clause 6, further comprising:
a second DDR DRAM including a third DDR DRAM interface, wherein the first die includes a fourth DDR DRAM interface coupled to the third DDR DRAM interface, and wherein the at least one processor is further configured to control the third DDR DRAM interface and the fourth DDR DRAM interface to be powered down during the remainder of the current discontinuous reception cycle in response to the second value of the wakeup signal.

Clause 8. The communication node of any of clauses 1-7, further comprising:
a power management integrated circuit, wherein the at least one processor is further configured to control the power management integrated circuit to power off a power supply voltage to the first die-to-die interface and the second die-to-die interface in response to the second value of the wakeup signal.

Clause 9. The communication node of any of clauses 1-8, wherein the communication node comprises a user equipment in a New Radio network, and wherein the wakeup signal comprises a ps_WakeUp_r16 signal.

Clause 10. A method for a user equipment; comprising
receiving a first wakeup signal, wherein the first wakeup signal is a command to power on a radio front end of the user equipment during an on-duration of a first discontinuous reception cycle;
maintaining a first die-to-die interconnect of a first processor die of the user equipment and a second die-to-die interconnect of a second processor die of the user equipment to be powered on during the on-duration of the first discontinuous reception cycle in response to the receiving of the first wakeup signal;
receiving a second wakeup signal, wherein the second wakeup signal is a command to maintain the radio front end of the user equipment to be powered off during an on-duration of a second discontinuous reception cycle; and
powering off the first die-to-die interconnect and the second die-to-die interconnect during at least a portion of the on-duration of the second discontinuous reception cycle in response to the receiving of the second wakeup signal.

Clause 11. The method of clause 10, further comprising:
starting a delay period in response to the receiving of the second wakeup signal; and
transmitting buffered data from the first processor die through the first die-to-die interconnect and through the second die-to-die interconnect to the second processor die during the delay period; and
wherein the powering off of the first die-to-die interconnect and of the second die-to-die interconnect occurs at a termination of the delay period.

Clause 12. The method of clause 11, wherein the delay period is a programmable delay period, and wherein the method further comprises:
programming a duration of the programmable delay period.

Clause 13. The method of clause 11, further comprising:
terminating the delay period upon a completion of a transmission of the buffered data.

Clause 14. The method of any of clauses 11-13, further comprising:
powering off a DRAM interface between at least one of the first processor die and the second processor die and at least one DRAM during at least the portion of the on-duration of the second discontinuous reception cycle in response to the receiving of the second wakeup signal.

Clause 15. A user equipment, comprising:
a first die including a first die-to-die interface and an at least one processor, wherein the at least one processor is configured to command the first die-to-die interface to power off prior to an on-duration of a current discontinuous reception cycle in response to a first value of a wakeup signal.

Clause 16. The user equipment of clause 15, wherein the at least one processor comprises an application processor and a baseband processor.

Clause 17. The user equipment of any of clauses 15-16, wherein the at least one processor is further configured to command a power management integrated circuit to power down a power supply voltage to the first die-to-die interface prior to the on-duration of the current discontinuous reception cycle in response to the first value of the wakeup signal.

Clause 18. The user equipment of any of clauses 15-17, further comprising:
a DDR DRAM including a first DDR DRAM interface coupled to a second DDR DRAM interface of the first die, wherein the at least one processor is further configured to command the first DDR DRAM interface and the second DDR DRAM interface to power down prior to the on-duration of the current discontinuous reception cycle in response to the first value of the wakeup signal.

Clause 19. The user equipment of any of clauses 15-18, wherein the wakeup signal comprises a ps_WakeUp_r16 signal, and wherein the first value is a binary zero value of a wake indication field of the ps_WakeUp_r16 signal.

Clause 20. The user equipment of any of clauses 15-19, wherein the at least one processor is further configured to command a transfer of buffered data over the first die-to-die interface prior to the power off of the first die-to-die interface.

As those of some skill in this art will by now appreciate and depending on the particular application at hand, many modifications, substitutions and variations can be made in and to the materials, apparatus, configurations and methods of use of the devices of the present disclosure without departing from the scope thereof as defined by the appended claims. In light of this, the scope of the present disclosure should not be limited to that of the particular implementations illustrated and described herein, as they are merely by way of some examples thereof, but rather, should be fully commensurate with that of the claims appended hereafter and their functional equivalents.

What is claimed is:

1. A communication node, comprising:
a radio front end configured to receive a wakeup signal, wherein the radio front end is further configured to be powered on during an on-duration of a current discontinuous reception cycle in response to a first value of the wakeup signal and to be powered down prior to and during the on-duration of the current discontinuous reception cycle in response to a second value of the wakeup signal;
a first die including a first die-to-die interface; and
a second die including a second die-to-die interface and an at least one processor, wherein the second die-to-die interface is coupled to the first die-to-die interface, and wherein the at least one processor is configured to control the first die-to-die interface and the second die-to-die interface to be powered off during a remainder of the current discontinuous reception cycle including the on-duration in response to the second value of the wakeup signal.

2. The communication node of claim 1, wherein the at least one processor is an application processor and wherein the second die includes a baseband processor.

3. The communication node of claim 1, wherein the at least one processor is a baseband processor and wherein the second die includes an application processor.

4. The communication node of claim 1, wherein the first die-to-die interface and the second die-to-die interface each comprises a peripheral component interconnect express interface.

5. The communication node of claim 1, wherein the first die-to-die interface and the second die-to-die interface each comprises a configurable general-purpose input/output (GPIO) interface.

6. The communication node of claim 1, further comprising:
a first double data rate dynamic random-access memory (DDR DRAM) including a first DDR DRAM interface, wherein the second die includes a second DDR DRAM interface coupled to the first DDR DRAM interface, and wherein the at least one processor is further configured to control the first DDR DRAM interface and the second DDR DRAM interface to be powered down during the remainder of the current discontinuous reception cycle in response to the second value of the wakeup signal.

7. The communication node of claim 6, further comprising:
a second DDR DRAM including a third DDR DRAM interface, wherein the first die includes a fourth DDR DRAM interface coupled to the third DDR DRAM interface, and wherein the at least one processor is further configured to control the third DDR DRAM interface and the fourth DDR DRAM interface to be powered down during the remainder of the current discontinuous reception cycle in response to the second value of the wakeup signal.

8. The communication node of claim 1, further comprising:
a power management integrated circuit, wherein the at least one processor is further configured to control the power management integrated circuit to power off a power supply voltage to the first die-to-die interface and the second die-to-die interface in response to the second value of the wakeup signal.

9. The communication node of claim 1, wherein the communication node comprises a user equipment in a New Radio network, and wherein the wakeup signal comprises a ps_WakeUp_r16 signal.

10. A method for a user equipment; comprising
receiving a first wakeup signal, wherein the first wakeup signal is a command to power on a radio front end of the user equipment during an on-duration of a first discontinuous reception cycle;
maintaining a first die-to-die interconnect of a first processor die of the user equipment and a second die-to-die interconnect of a second processor die of the user equipment to be powered on during the on-duration of the first discontinuous reception cycle in response to the receiving of the first wakeup signal;
receiving a second wakeup signal, wherein the second wakeup signal is a command to maintain the radio front end of the user equipment to be powered off during an on-duration of a second discontinuous reception cycle; and
powering off the first die-to-die interconnect and the second die-to-die interconnect during at least a portion of the on-duration of the second discontinuous reception cycle in response to the receiving of the second wakeup signal.

11. The method of claim 10, further comprising:
starting a delay period in response to the receiving of the second wakeup signal; and
transmitting buffered data from the first processor die through the first die-to-die interconnect and through the second die-to-die interconnect to the second processor die during the delay period; and
wherein the powering off of the first die-to-die interconnect and of the second die-to-die interconnect occurs at a termination of the delay period.

12. The method of claim 11, wherein the delay period is a programmable delay period, and wherein the method further comprises:
programming a duration of the programmable delay period.

13. The method of claim 11, further comprising:
terminating the delay period upon a completion of a transmission of the buffered data.

14. The method of claim 11, further comprising:
powering off a DRAM interface between at least one of the first processor die and the second processor die and at least one DRAM during at least the portion of the on-duration of the second discontinuous reception cycle in response to the receiving of the second wakeup signal.

15. A user equipment, comprising:
a first die including a first die-to-die interface and an at least one processor, wherein the at least one processor is configured to command the first die-to-die interface to power off prior to an on-duration of a current discontinuous reception cycle in response to a first value of a wakeup signal.

16. The user equipment of claim 15, wherein the at least one processor comprises an application processor and a baseband processor.

17. The user equipment of claim 15, wherein the at least one processor is further configured to command a power management integrated circuit to power down a power supply voltage to the first die-to-die interface prior to the on-duration of the current discontinuous reception cycle in response to the first value of the wakeup signal.

18. The user equipment of claim 15, further comprising:
a DDR DRAM including a first DDR DRAM interface coupled to a second DDR DRAM interface of the first die, wherein the at least one processor is further configured to command the first DDR DRAM interface and the second DDR DRAM interface to power down prior to the on-duration of the current discontinuous reception cycle in response to the first value of the wakeup signal.

19. The user equipment of claim 15, wherein the wakeup signal comprises a ps_WakeUp_r16 signal, and wherein the first value is a binary zero value of a wake indication field of the ps_WakeUp_r16 signal.

20. The user equipment of claim 15, wherein the at least one processor is further configured to command a transfer of buffered data over the first die-to-die interface prior to the power off of the first die-to-die interface.
